(19) United States
(12) Patent Application Publication
(10) Pub. No.: US 2016/0204880 A1
(43) Pub. Date: Jul. 14, 2016

(54) SOUND WAVE COMMUNICATION SYSTEM EQUIPPED WITH SOUND WAVE SIGNAL OUTPUT DEVICE, AND PORTABLE TERMINAL DEVICE USING THIS SYSTEM

(71) Applicant: INTEC INC., Toyama-shi, Toyama (JP)

(72) Inventors: Takahiro Endo, Kanagawa (JP); Kenichi Nagami, Kanagawa (JP)

(73) Assignee: INTEC INC., Toyama-shi, Toyama (JP)

(21) Appl. No.: 14/912,970

(22) PCT Filed: Jun. 16, 2014
(86) PCT No.: PCT/JP2014/003210

§ 371 Date: Feb. 19, 2016

(30) Foreign Application Priority Data
Aug. 22, 2013 (JP) 2013-172712

(51) Int. Cl. H04B 11/00

(52) U.S. Cl. CPC H04B 11/00

(57) ABSTRACT

ID transmitters, each of which can output a sound wave signal comprising sine waves of different frequencies, are installed apart from one another so that areas where each sound wave signal reaches are different. A predetermined number of frequencies, which are included in a frequency range that uses an uppermost audio frequency range, correspond to a predetermined number of bits with the value of each bit being expressed by the presence or absence of the output of the sine wave of the corresponding frequency. Information is divided into items of partial information with each item of partial information being expressed by at least part of the predetermined number of bits of the sound wave signal. An ID transmitter switches at predetermined time intervals the sound wave signal to be outputted, thereby cyclically outputting sound wave signals expressing the items of partial information in the order the information is formed.

### RELATED APPLICATION

This application claims the benefit of Japanese Patent Application No. 2013-172712 filed on Aug. 22, 2013 in Japan, the contents of which are incorporated herein by reference.

### TECHNICAL FIELD

The present invention relates to a technology to use sound wave signal output devices installed at their respective places to recognize the location of a moving portable terminal at the moment and provide information or services according to each location.

### BACKGROUND ART

In recent years, it has been popular to use the indoor positioning technology in buildings, stores, or the like to obtain a portable terminal user's positional information in real time while the user is walking to provide information or services dependent on the positional information (e.g. see Non-patent document 1).

The present applicant has developed a technology to realize the positioning with a sound wave signal using an uppermost audio frequency range to provide location-related services (e.g. see Patent document 1).

### PRIOR ART DOCUMENTS

### Patent Document

Patent document 1: Japanese Patent Laid-Open Application No. 2013-106278

### Non-Patent Document

Non-patent document 1: Tokushu; Ayumidasu Okunai Sokui (Feature article; Indoor Positioning Begins), May 27 issue of Nikkei Electronics (2013), 27-41

### SUMMARY OF THE INVENTION

### Problems to be Solved by the Invention

A method shown in Patent document 1 has the advantages that it can be operated even in such environments as indoor and underground space, can support a portable terminal user moving on foot and, without damaging the view of the operating environment, can use an audio input function or the like commonly integrated into a portable terminal to acquire information identifying a location.

The high-speed processing performance to be able to support the movement on foot is achieved not by using a modulated carrier sound wave signal carrying information but by using a sound wave signal simply superimposed with sine waves of one or more frequencies different from one another to express the value of a bit by the presence or absence of a predetermined frequency in the superimposed signal. This is because such method does not require time for waiting for the whole modulated carrier wave to be received for demodulation and can simultaneously acquire the values of a plurality of bits and instantly restore the information only by detecting frequencies of sine waves with the fast Fourier transform or the like.

As described above, the method has the characteristic of being capable of simultaneously acquiring the values of a plurality of bits in a place where an identical sound wave signal is continuously outputted and no matter when the sound wave signal is received. But the number of bits (the amount of information) that can be transmitted is limited because the available frequency range is limited to a range that is hardly audible to humans and can be inputted with common portable terminals and because the narrowness of the spacing between the plurality of frequencies that are made to correspond to the plurality of bits is also limited due to detection accuracy.

When multiple sound wave signal output devices are used to uniquely identify multiple locations, however, there comes a demand for increasing the amount of information (the uniquely identifiable number) that can be transmitted by the sound wave signal.

A purpose of the invention is, in a system for transmitting location-related information to a portable terminal by a sound wave signal, to increase the amount of information that can be transmitted while maintaining the high-speed processing performance to be able to support a portable terminal user moving on foot.

### Means for Solving the Problems

A sound wave signal output device of one example consistent with the principle of the invention comprises means for outputting a sound wave signal comprising one or more sine waves of different frequencies in such a way that a predetermined number of frequencies, which are included in a frequency range that uses an uppermost audio frequency range, correspond to a predetermined number of bits with the value of each bit being expressed by the presence or absence of the output of the sine wave of the corresponding frequency, where information to be transmitted by using the sound wave signal is capable of being associated with a place where the sound wave signal output device is installed, and is divided into a plurality of items of partial information with each item of partial information being expressed by at least part of the predetermined number of bits of the sound wave signal. The sound wave signal output device comprises means for switching at predetermined time intervals the sound wave signal to be outputted, and cyclically outputs sound wave signals expressing the items of partial information in the order the information is formed.

### Advantages of the Invention

As described above, the invention allows a system for transmitting location-related information to a portable terminal by a sound wave signal to increase the amount of information that can be transmitted while maintaining the high-speed processing performance to be able to support a portable terminal user moving on foot. In addition, since the sound wave signal switched at predetermined time intervals is less likely to be generated in nature or from another system, the invention has another advantage of reducing the likelihood of the portable terminal erroneously acquiring information that is not transmitted.

### BRIEF DESCRIPTION OF THE DRAWINGS

FIG. 1 shows a general configuration of a sound wave communication system of one example of an embodiment of the invention;

FIG. 2 shows one example of an ID information table controlled by an ID control server;

FIG. 3 shows the structure of time slots (TS) in a first scheme of the embodiment;

FIG. 4 show one example of the allocation of sound wave frequencies (kHz) to a bit string of TS;

FIG. 5 shows one example of the structure of frames in the embodiment;

FIG. 6 shows one example of the internal configuration of an ID transmitter;

FIG. 7 shows one example of the functional configuration of a portable terminal;

FIG. 8 shows one example of the structure of a primary cache in the portable terminal;

FIG. 9 shows one example of the structure of a secondary cache in the portable terminal;

FIG. 10 shows one example of a positional information table controlled by a position control server;

FIG. 11 shows one example of a content information table controlled by a content server;

FIG. 12 illustrates how a positional ID is transmitted by the first scheme of the embodiment;

FIG. 13 illustrates the temporal progression of a sound wave signal transmitted by the first scheme of the embodiment;

FIG. 14 illustrates one example of the relation between the intervals of a fast Fourier transform (FFT) and the time slots;

FIG. 15 is a flowchart showing one example of a process for restoring a temporally divided sound wave signal;

FIG. 16 shows the structure of TSs and a frame in a second scheme of the embodiment; and

FIG. 17 shows the structure of TSs and a frame in a third scheme of the embodiment.

### MODES OF EMBODYING THE INVENTION

The configuration of one example consistent with the principle of the invention described above can only transmits at most an amount of information comparable to the above-described predetermined number of bits with just the sound wave signal at one point in time, but can divide information to be transmitted into a plurality of pieces to use the sound wave signal at a plurality of points in time, therefore allowing for the increase in the amount of information that can be transmitted.

In order to allow the portable terminal, to which such sound wave signal is inputted, to restore information by repeating several times the simultaneous acquisition of the values of a plurality of bits no matter when it receives the sound wave signal, the following configurations can be added, for example.

In a first configuration, part of the predetermined number of bits of the sound wave signal are made to express one of the items of partial information, and a remaining part are made to express information that indicates which part of the information said one of the items of partial information forms. This allows the portable terminal inputted with the sound wave signal to determine, from the sound wave signal itself, which part of the information to be restored the item of partial information received with the sound wave signal corresponds to.

In a second configuration, at least part of the predetermined number of bits of the sound wave signal to be outputted at a certain point in time are made to express information that indicates the start of the information, at least part of the predetermined number of bits of each of the sound wave signals to be subsequently switched on and outputted in turn are made to express one of the items of partial information, and at least part of the predetermined number of bits of the sound wave signal to be thereafter switched on and outputted are made to express information that indicates the end of the information.

In a third configuration, at least part of the predetermined number of bits of the sound wave signal to be outputted at a certain point in time are made to express information that indicates which part of the information one of the items of partial information expressed by the sound wave signal to be subsequently outputted forms, and at least part of the predetermined number of bits of the sound wave signal to be subsequently switched on and outputted are made to express said one of the items of partial information.

In either of the configurations described above, a remaining part of the predetermined number of bits of the sound wave signal may form a code for detecting an error in the predetermined number of bits. In addition, making this code allow for error correction can increase the likelihood of obtaining the correct value as each value of the predetermined number of bits. In this configuration, when the predetermined number of bits could not be received for one item of partial information, the sound wave signal including the same item of partial information is outputted again after the sound wave signal including the other items of partial information are outputted in turn, and therefore the error correction can decrease the likelihood of having to wait until then.

A sound wave signal control device of one example consistent with the principle of the invention controls a sound wave signal to be outputted by each of a plurality of sound wave signal output devices, and comprises: means for allocating, to each of the sound wave signal output devices, information capable of being associated with a place where said each of the sound wave signal output devices is installed, as information to be transmitted by using the sound wave signal; means for generating data of a sound wave signal in such a way that the sound wave signal is outputted continuously for a predetermined period of time, the sound wave signal comprising one or more sine waves of different frequencies in such a way that a predetermined number of frequencies, which are included in a frequency range that uses an uppermost audio frequency range, correspond to a predetermined number of bits with the value of each bit being expressed by the presence or absence of the output of the sine wave of the corresponding frequency; means for generating data of the sound wave signals in such a way that the information is divided into a plurality of items of partial information with each item of partial information being expressed by at least part of the predetermined number of bits, and connecting the data of the sound wave signals for respective items of partial information in the order the information is formed; and means for passing the connected data of the sound wave signals to the sound wave signal output device allocated with the information.

The sound wave signal control device described above may cause each sound wave signal output device to repeatedly replay the connected data of the sound wave signal so that the sound wave signal to be outputted is switched at predetermined time intervals, and that sound wave signals expressing the items of partial information are cyclically outputted in the order the information is formed.

A portable terminal device of one example consistent with the principle of the invention comprises means for inputting a sound wave signal comprising one or more sine waves of different frequencies in such a way that a predetermined number of frequencies, which are included in a frequency range that uses an uppermost audio frequency range, correspond to a predetermined number of bits with the value of each bit being expressed by the presence or absence of the output of the sine wave of the corresponding frequency, where information transmitted by using the sound wave signal is capable of being associated with a place where a device for outputting the sound wave signal is installed, and is divided into a plurality of items of partial information with each item of partial information being expressed by at least part of the predetermined number of bits of the sound wave signal. The portable terminal device comprises: means for determining respective values of the predetermined number of bits by detecting frequencies of one or more sine waves that form the inputted sound wave signal at predetermined time intervals; and means for restoring the information by storing the items of partial information obtained based on the respective values of the predetermined number of bits and by assembling the stored plurality of items of partial information in order.

This configuration allows the portable terminal device that detected frequencies of sine waves to obtain an item of partial information included in the sound wave signal by, for example, converting them into a bit string in such a way that the value for frequencies detected in the sequence of the predetermined number of frequencies is 1 and the value for frequencies not detected in the sequence of the predetermined number of frequencies is 0, and allows the information to be restored quickly by performing this process on the plurality of items of partial information.

The portable terminal device described above may restore the information by obtaining one of the items of partial information from respective values of part of the predetermined number of bits and obtaining information that indicates which part of the information said one of the items of partial information forms from respective values of a remaining part of the predetermined number of bits. This corresponds to the first configuration described above.

In the portable terminal device, the means for restoring the information may repeat a process to, after restoring the information, newly store the items of partial information obtained based on respective values of the predetermined number of bits and restore the information from the newly stored plurality of items of partial information, and the portable terminal device may further comprise means for determining that the information is acquired without error if identical information is obtained for a predetermined number of times in a row.

This can improve the reliability of information restored by the portable terminal device being the information that should be transmitted by the sound wave signal. Since in the present configuration the whole information that should be transmitted is not received at one time but is temporally divided into a plurality of items of partial information and received, there is more likelihood that the information cannot be restored correctly due to the increased possibility of error in the sound wave signal coming through free space or due to part of the plurality of items of partial information being received from one sound wave signal output device and the rest being received from another, but the configuration described above can eliminate such problems.

In order to increase the possibility of correctly obtaining the predetermined number of bits for an item of partial information, the portable terminal may further comprise means for using respective values of part of the predetermined number of bits as a code for error detection to detect and, if correctable, correct an error in respective values of said predetermined number of bits.

Sound wave signals from the device for outputting the sound wave signal may be switched at predetermined time intervals to be outputted, and the time interval at which the portable terminal device detects the frequencies may be set equal to or less than half the time interval at which the device for outputting the sound wave signal switches the sound wave signal.

In the present configuration the timing of when to output the sound wave signal from the sound wave signal output device is not in synchronization with the timing of when to input the sound wave signal in the portable terminal device, and the outputted sound wave signal may be switched in the middle of the time period to input one sound wave signal in the portable terminal device. In the configuration described above, however, since the length of the time period for each input is set equal to or less than half (or ⅓) the length of the time period to switch the output, and therefore the number of time periods in which the sound wave signal is switched in the middle and a reception error occurs is equal to or less than one out of two (or one out of three), a correct sound wave signal will be inputted at least one time within the time period in which one sound wave signal is being outputted.

In order for the portable terminal device to be able to deal with the periodic switching between the time period of erroneous reception and the time period of successful reception as described above, the means for storing the items of partial information obtained based on respective values of the predetermined number of bits may store one of the items in such a way that which part of the information said one of the items of partial information forms is distinguished, and if an item of partial information obtained based on respective values of the predetermined number of bits and an item of partial information already stored form an identical part, one of the two items may be chosen to be used for restoring the information.

A sound wave communication system of one example consistent with the principle of the invention transmits information to a portable terminal by using a plurality of sound wave signal output devices that comprise means for outputting a sound wave signal comprising one or more sine waves of different frequencies and are installed apart from one another so that areas where each sound wave signal reaches are different from one another. The sound wave signal is formed in such a way that a predetermined number of frequencies, which are included in a frequency range that uses an uppermost audio frequency range, correspond to a predetermined number of bits with the value of each bit being expressed by the presence or absence of the output of the sine wave of the corresponding frequency, and information to be transmitted to the portable terminal is capable of being associated with the place where each sound wave signal output device is installed, and is divided into a plurality of items of partial information with each item of partial information being expressed by at least part of the predetermined number of bits of the sound wave signal. The sound wave signal output devices comprise means for switching at first predetermined time intervals the sound wave signal to be outputted, and cyclically output sound wave signals expressing the items of partial information in the order the information is formed, and the portable terminal performs a process to determine respective values of the predetermined number of bits by detecting frequencies of one or more sine waves that form the inputted sound wave signal at second predetermined time intervals and, when a plurality of items of partial information obtained based on the respective values of the predetermined number of bits are stored, restore the information by assembling the items in order.

The first predetermined time interval may be determined so that the time required for the portable terminal performing the process to input the sound wave signal to obtain an item of partial information as many times as the number of items of partial information that form the information is less than the time required for the portable terminal moving a desired minimum distance. This allows for the reliable maintenance of the high-speed processing performance to be able to support a portable terminal user moving on foot.

If the portable terminal repeats a process to, after restoring the information, restore the information from the items of partial information newly obtained based on respective values of the predetermined number of bits, and determines that the information is acquired without error if identical information is obtained for a predetermined number of times in a row, the first predetermined time interval may be determined so that the time required for the portable terminal repeating the predetermined number of times performing the process to input the sound wave signal to obtain an item of partial information as many times as the number of items of partial information that form the information is less than the time required for the portable terminal moving a desired minimum distance. This allows for support for a portable terminal user moving on foot while increasing the reliability of restored information.

As described before, the first and second predetermined time intervals may be determined so that the first predetermined time interval is more than twice as long as the second predetermined time interval.

The second predetermined time interval may be determined so that any of the predetermined number of frequencies included in a frequency range that uses an uppermost audio frequency range can be detected with a desired accuracy.

The sound wave communication system described above may further comprise a server device that provides service information unique to the place associated with the information (e.g. positional information and/or content information, etc.) in response to an inquiry based on the information from the portable terminal.

The principle of the invention of the sound wave signal output device described above may also be realized by a sound wave signal control device, a portable terminal device, or by a sound wave communication system; the principle of the invention of the portable terminal device described above may also be realized by a sound wave communication system; and the principle of the invention of the sound wave communication system described above may also be realized by a sound wave signal output device, a sound wave signal control device, or by a portable terminal device. In addition, the principle of the invention of the devices and systems described above may also be realized by a method, or by a program (or a recording medium on which such program is recorded).

For example, a computer program of one example consistent with the principle of the invention is installed on a computer to cause the computer to operate as a sound wave signal control device for controlling a sound wave signal to be outputted by each of a plurality of sound wave signal output devices. The computer program comprises: a program code for executing a process for allocating, to each of the sound wave signal output devices, information capable of being associated with a place where said each of the sound wave signal output devices is installed, as information to be transmitted by using the sound wave signal; a program code for executing a process for generating data of a sound wave signal in such a way that the sound wave signal is outputted continuously for a predetermined period of time, the sound wave signal comprising one or more sine waves of different frequencies in such a way that a predetermined number of frequencies, which are included in a frequency range that uses an uppermost audio frequency range, correspond to a predetermined number of bits with the value of each bit being expressed by the presence or absence of the output of the sine wave of the corresponding frequency; a program code for executing a process for generating data of the sound wave signal in such a way that the information is divided into a plurality of items of partial information with each item of partial information being expressed by at least part of the predetermined number of bits, and connecting the data of the sound wave signals for respective items of partial information in the order the information is formed; and a program code for executing a process for passing the connected data of the sound wave signal to the sound wave signal output device allocated with the information.

For another example, a portable terminal device program of one example consistent with the principle of the invention is installed on a portable terminal device comprising means for inputting a sound wave signal comprising one or more sine waves of different frequencies. The sound wave signal is formed in such a way that a predetermined number of frequencies, which are included in a frequency range that uses an uppermost audio frequency range, correspond to a predetermined number of bits with the value of each bit being expressed by the presence or absence of the output of the sine wave of the corresponding frequency, and information transmitted by using the sound wave signal is capable of being associated with a place where a device for outputting the sound wave signal is installed, and is divided into a plurality of items of partial information with each item of partial information being expressed by at least part of the predetermined number of bits of the sound wave signal. The program comprises: a program code for executing a process for determining respective values of the predetermined number of bits by detecting frequencies of one or more sine waves that form the inputted sound wave signal at predetermined time intervals; and a program code for executing a process for restoring the information by storing the items of partial information obtained based on the respective values of the predetermined number of bits and by assembling the stored plurality of items of partial information in order.

Now, a sound wave communication system of an embodiment of the invention will be described, by way of example, with reference to the drawings.

The sound wave communication system of the present example is generally driven by the following technology. Sound signals in a high-tone range barely audible to human ears (hereinafter sometimes referred to as inaudible sound waves in a human point of view, but these are sound wave signals in an uppermost audio frequency range in the sense that they can be inputted through a microphone) are continuously transmitted from ID transmitters installed in different places in a specific space (e.g. a building, a store, etc.).

While a person carrying a portable terminal walks around the specific space, the portable terminal receives a sound wave signal transmitted in each place using a microphone built in the terminal and acquires a positional ID contained in the relevant signal.

The portable terminal can use the acquired positional ID to make an inquiry to a server over a network or to search for information cached in the terminal so that it can receive positional information on the place or content associated with the place (both are information desired by the system to provide to the portable terminal that has come to the place and received the sound wave signal from the ID transmitter, and are hereinafter sometimes referred to as positional information etc.).

When a human being walks at 4.8 km/h, the time required for moving 1 m is 750 ms and, if the process to receive a sound wave signal and obtain a positional ID can be finished within this time, the positional ID can be acquired within two footsteps. In that case, even if a human being continues to walk at good speed without a stop, the places moved through can be detected in sufficient detail as long as many ID transmitters are densely arranged in the space, and when some notification is to be made actively for a portable terminal that comes to a certain place or on similar occasions, information can be made to be received even if the time during which the portable terminal is within reach of the ID transmitter's sound wave is short.

The sound wave signal uses, for example, an uppermost audio frequency range (also referred to as ultrasound) from the order of 15 kHz to the order of 22 kHz. Sound in this range is inaudible to ordinary people, and the signal can be outputted without being noticed by surrounding people. In order to decrease the possibility of being audible, the lower limit of the sound range to be used is more preferably on the order of 17 kHz. The use of this frequency range also allows the ID transmitters to be formed with commercially available speakers or the like and allows the portable terminal to be formed with a commercially available smartphone or the like, not with devices dedicated to ultrasonics. In order to allow a wider range of devices to be used, the upper limit of the sound range to be used is more preferably on the order of 20 kHz.

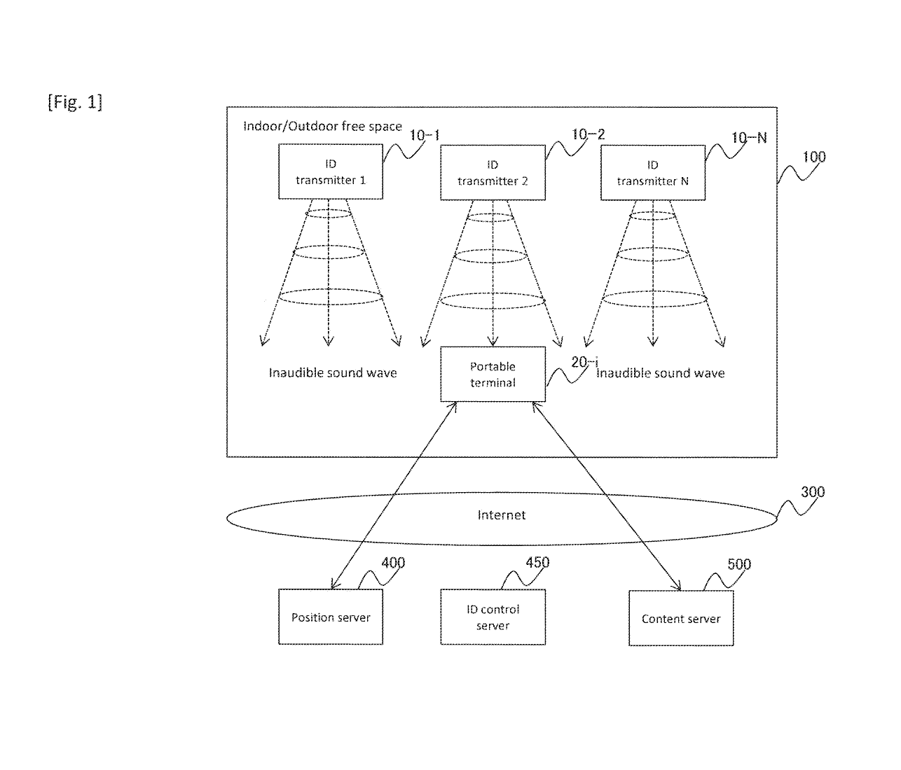

As shown in FIG. 1 for example, the system applied with the present technology comprises ID transmitters 10-n (n=1 to N) that are installed in different places in indoor or outdoor free space 100 and transmit positional IDs via inaudible sound waves. A plurality of users having their own portable terminal (portable information device that can use sound including a smartphone or tablet, for example) 20-i can walk around this free space 100. The portable terminal 20-i applied with the present technology has a function to, when it comes within reach of a sound wave signal transmitted from an ID transmitter, receive the sound wave signal and extract the positional ID contained therein.

The system applied with the present technology may further comprise: a position server 400 for providing the portable terminal 20-i with positional information corresponding to the positional ID; and/or a content server 500 for providing the portable terminal 20-i with content corresponding to the positional ID. The system may also comprise an ID control server 450 for controlling positional IDs transmitted by the ID transmitters 10-n. The portable terminal 20-i and the position server 400 and content server 500 communicate with each other over the Internet 300 or through other network facilities (a wireless LAN, a mobile phone network, etc.).

A 32-bit or larger globally unique address space is used for positional IDs in the present example. The ID control server 450 generates and controls positional IDs in a centralized way so that they are not redundantly generated or used. Positional IDs are generated in such a way that they are created one by one continuously from unused space, that arbitrarily-specified unused IDs are created one by one, that they are created collectively with the range being specified, or that arbitrarily-specified created IDs are re-created.

The ID control server 450 also has a function to convert a generated positional ID into a sound wave signal to generate a sound wave signal file. The sound wave signal file is outputted in a music file format. When a plurality of files are generated, they are archived into a zip file. A system administrator copies generated sound wave signal files to an SD card or a USB memory and loads them into embedded memory of each ID transmitter 10-n. Alternatively, if each ID transmitter 10-n and the ID control server 450 can communicate with each other over the network, the ID control server 450 may transmit the sound signal files to each ID transmitter 10-n.

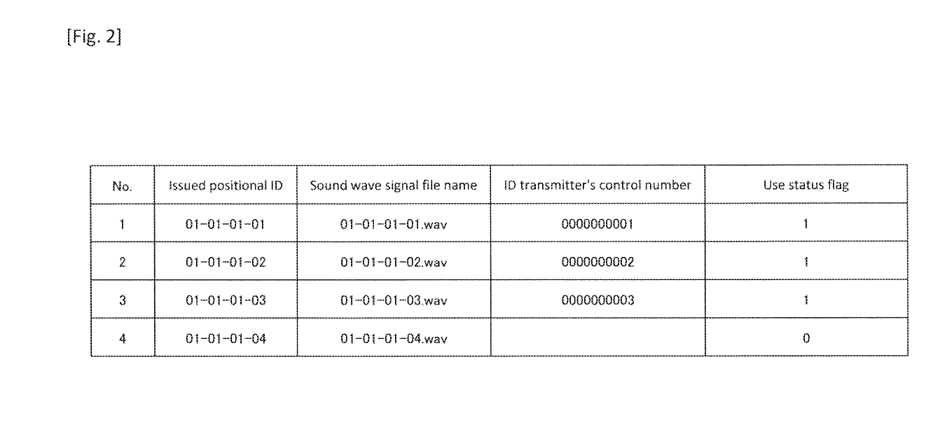

The ID control server 450 includes an ID control database, a table of which contains Issued positional ID, Sound wave signal file name, ID transmitter's control number, and Use status flag as shown in FIG. 2, for example. Generated positional IDs are registered on the Issued positional ID column in such a way that consecutive positional IDs are lined up. When a sound wave signal file of a certain positional ID is generated, a sound wave signal file name corresponding to the positional ID is registered. When there is an ID transmitter that uses a certain Issued positional ID, the ID transmitter's control number corresponding to the positional ID is registered, and its Use status flag is turned to 1. An inventory of positional IDs can be taken by setting the Use status flag for unused positional IDs to 0.

The ID control server 450 and the position server 400 and/or content server 500 may be connected to each other over a network or the like to be allowed to interact with each other so that a positional ID being in use means that positional information from the position server 400 and/or content information from the content server 500 is available for the positional ID.

Represented in hex and separated by “-” (hyphen) every eight bits, a positional ID with 32-bit space is written, for example, as follows: 01-01-01-01, 01-02-03-04, aa-bb-cc-dd, or the like. A procedure for converting this positional ID into an inaudible sound wave signal will be described in the following.

One field of a positional ID separated by “-” is called an octet. A positional ID in the present example has four octets, namely, from the first to the fourth octet. For example, if a positional ID is “01-01-01-01,” the first octet is “01” (1 in decimal), the second octet is “01” (same as above), the third octet is “01” (same as above), and the fourth octet is “01” (same as above).

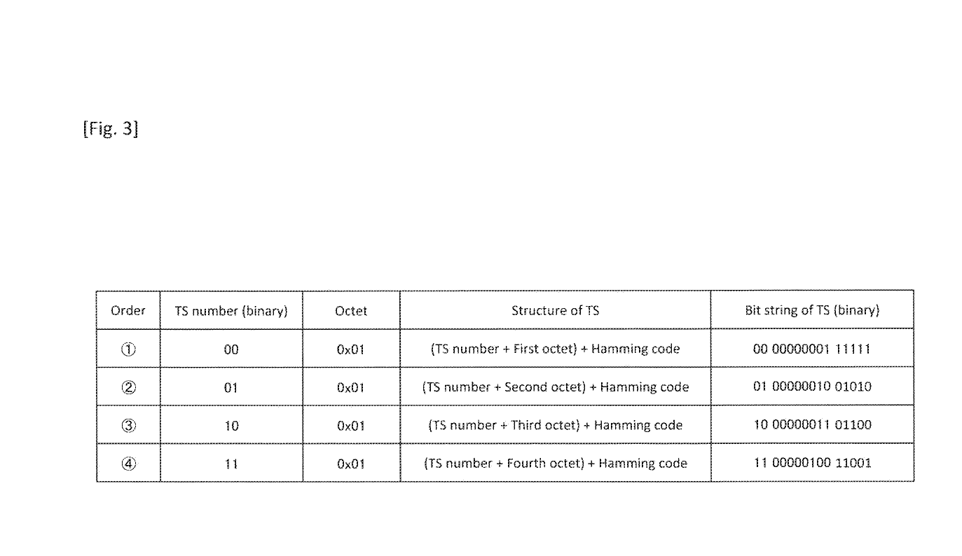

As a sound wave signal, the items of information of the first to the fourth octets are connected together on a time-series basis and are repeated for a certain period of time. When connected, as shown in FIG. 3, the first octet is entered in the first time slot (Order (1)), the second octet is entered in the second time slot (Order (2)), the third octet is entered in the third time slot (Order (3)), and the fourth octet is entered in the fourth time slot (Order (4)).

Each time slot (TS) in the present example has a length of at least 15 bits. A time slot includes eight bits indicating each octet information and two additional bits indicating the order of the time slot (TS number). The TS number of the first time slot is “00,” the TS number of the second time slot is “01,” the TS number of the third time slot is “10,” and the TS number of the fourth time slot is “11.”

As for each time slot (TS) in the present example, a Hamming code is further calculated for 10-bit data of the bit string of the octet information described above coupled with the two bits of the order of the time slot, and the data of 15 bits altogether including the calculated five bits is entered in the time slot.

The five bits to be coupled here are in consideration of the likelihood of frequent signal loss or the like due to the propagation of the sound wave signal in free space, and are used for error detection and correction. The present example uses an error detection and correction code scheme, adopting two-bit error detection and one-bit error correction.

In this regard, FIG. 3 is just one example, so the number of bits of the sound wave signal need not be 15, the number of bits of TS number is not limited to two, the number of bits of a divided positional ID (an ID element; an octet in the above example) is not limited to eight, and the number of bits of the error detection and correction code (the redundancy code; the Hamming code in the above example) need not be five (or, alternatively, error detection or correction does not have to be done).

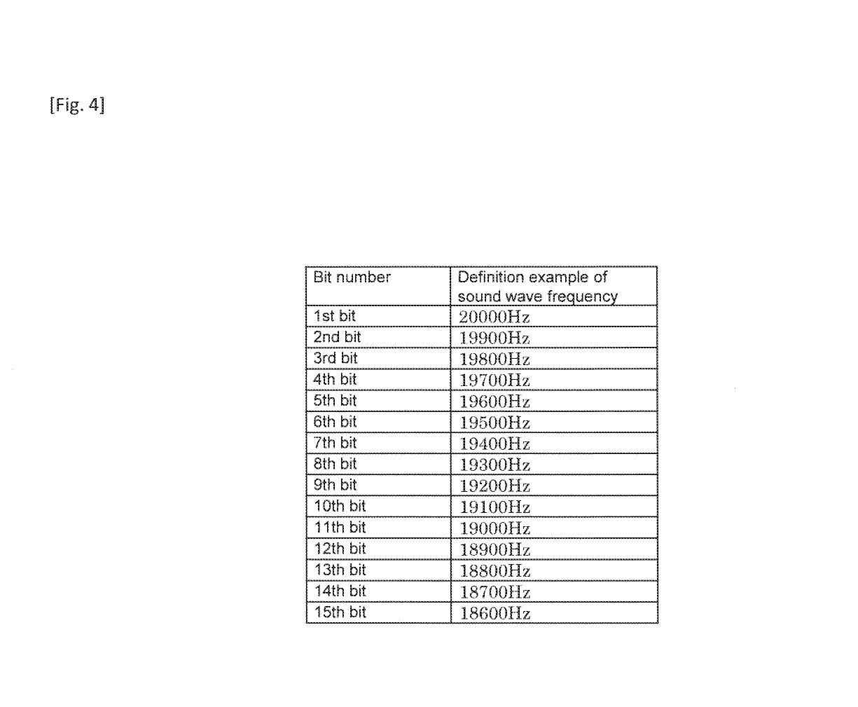

The 15-bit bit string of a time slot is then converted into a sound wave signal. A sound wave frequency corresponding to each bit is determined in advance, and the bit string is converted into sound waves in accordance with a table such as shown in FIG. 4. The example in FIG. 4 uses frequencies ranging from 18 kHz to 20 kHz, and a sound wave of (20000−(k−1)×100) Hz is generated if the kth bit (k=1 to 15) is 1, or the sound wave of the relevant frequency is not generated if it is 0. Accordingly, if m bits out of the 15 bits are 1, m sound waves (sine waves) of different frequencies will be outputted simultaneously as a sound wave signal.

The sound wave signal of the embodiment does not carry bit string information by modulating a carrier wave, but expresses bit string information, with 15 sine waves of different frequencies being made to correspond to the 15 bits, by the presence or absence of each sine wave. Based on a result of a fast Fourier transform (FFT), the side receiving the sound wave signal restores bit string information in such way that If it has been able to acquire a relevant frequency component, it recognizes the bit as 1, while if it has not been able to acquire the frequency component, it recognizes the bit as 0. The present scheme allows for fast signal acquisition and analysis since it does not involve modulation and demodulation and allows information of all bits to be received simultaneously.

The spacing between the frequency of each sine wave composing the sound wave signal can be set approximately to 50-200 Hz, for example (100 Hz in the example in FIG. 4). Since the width of the uppermost audio frequency range is limited, information of greater number of bits can be contained if the frequency spacing is decreased but, on the other hand, if the frequency spacing is decreased, the sampling number needs to be increased in order to eliminate interference at the time of the FFT analysis, resulting in the need to increase the duration of a time slot (or to increase the sampling frequency, though causing the implementation of the FFT to be complicated). The frequency spacing suited to the characteristics of each system may be determined in consideration of these factors.

In the present example, the duration of one time slot is set to a predetermined time equal to or less than 50 ms, and a sound wave signal for each time slot (four sound wave signals in the present example) is generated. That is, the sine wave of each frequency described above is continuously outputted for the duration of a time slot. After that, the sound wave signals are connected together from the first time slot to the fourth time slot in order, to create a sound wave signal that continues for a predetermined time equal to or less than 200 ms. This sound wave signal is called a frame.

So, in the present scheme, when the duration of a frame is 200 ms, a sound wave signal containing information of the first ¼ bit string of a positional ID is continuously outputted for 0-50 ms in the duration, a sound wave signal containing information of the second ¼ bit string of the positional ID is continuously outputted for 50-100 ms, a sound wave signal containing information of the third ¼ bit string of the positional ID is continuously outputted for 100-150 ms, and a sound wave signal containing information of the last ¼ bit string of the positional ID is continuously outputted for 150-200 ms.

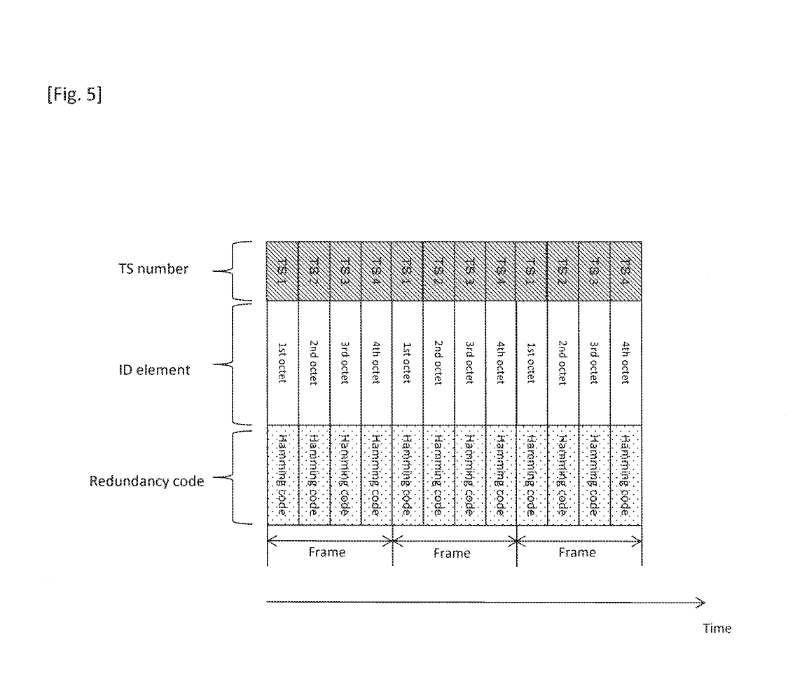

As shown in FIG. 5, a frame is repeated an arbitrary number of times (three times in the example in FIG. 5) to create a sound wave signal file. A sound wave signal file stores signals of a limited number of frames but, since an ID transmitter 10-n continues to replay from the start after replaying a recorded sound wave signal and thereby continuously outputs the sound wave signal having an identical periodic change, a sound wave signal file only has to store a signal of one frame.

When converting a plurality of positional IDs into their respective sound wave signal files, the ID control server 450 is allowed to choose to automatically archive the created signal files. The sound wave signal files created here are in WAV, AIFF, MP3, or other file formats.

When a sound wave signal file is created, the signal to be contained in the file can be composed of two channels so as to record a sound wave signal indicating a positional ID on one channel and record a sine wave (replay status signal) of a specified frequency (which may be a frequency without the uppermost audio frequency range) on the other channel.

Positional ID information is transmitted through free space by an ID transmitter 10-n replaying a sound wave signal from a sound wave signal file and outputting it from a speaker or the like, thereby including it into an inaudible sound wave as described before. When the signal to be included into a sound wave signal file is one-channel, only a sound wave signal indicating a positional ID is recorded.

When the signal to be included into a sound wave signal file is two-channel, an ID transmitter 10-n replays a sound wave signal indicating a positional ID and also the replay status signal contained in the same file, simultaneously, and therefore the state of this replay status signal's being actually replayed can be detected to indicate the state of the relevant ID transmitters transmitting a sound wave with an LED or other indicators. Since the sound wave is invisible and inaudible to human eyes, it is convenient for operation and control to be able to visually confirm that the sound wave is being transmitted.

In this regard, the indication that a sound wave signal indicating a positional ID is being transmitted to the outside of an ID transmitter is made in the present example based on the state in which the replay status signal is being replayed inside the ID transmitter. In order to inform of the replay status more accurately, however, whether the relevant ID transmitter is transmitting the sound wave or not may be detected by: recording in advance, as the replay status signal, a sine wave of a frequency that is within the uppermost audio frequency range but is not used to express any bit of the positional ID; outputting the replay status signal as well from the speaker; and inputting it through a microphone.

Alternatively, in order to indicate with an indicator not just whether the sound wave is being transmitted or not but also whether the sound wave is being transmitted normally or not, a process may be repeated which the sound wave signal transmitted into free space is inputted through a microphone and the sound wave signal is analyzed by using the above-described error detection code, and then an indication such as lighting an LED lamp indicating an abnormality may be made when an error is detected (or when an error is detected and cannot be corrected).

In the example in which the replay status or sound wave transmission status is detected by inputting the replay status signal or sound wave signal through a microphone, the ID transmitter itself that transmits the sound wave signal may have the microphone, or a portable terminal of a system administrator or the like may have the microphone and send a detection result to an indicator. As for the indicator, too, each ID transmitter may have it to indicate their own status, or a center collectively controlling a plurality of ID transmitters (or the ID control server 450) may have it.

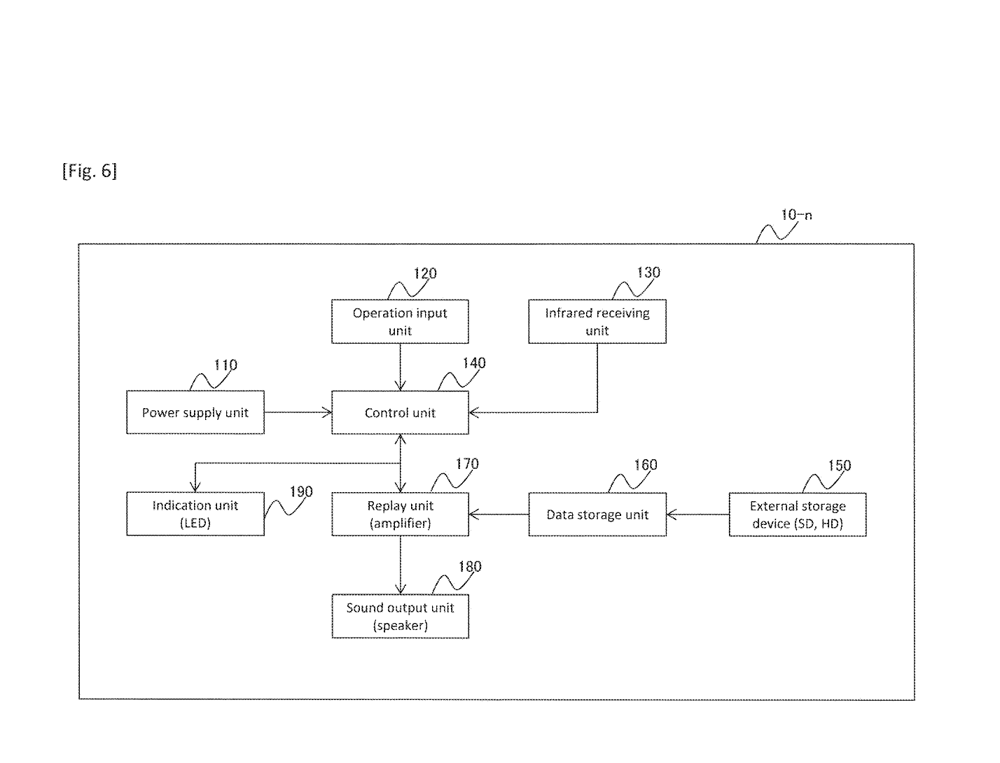

FIG. 6 shows an example of the internal configuration of an ID transmitter 10-n. The ID transmitter 10-n in FIG. 6 can transmit a sound wave signal independently without being connected to a network, and comprises: a power supply unit 110 for supplying power from the outside; an operation input unit 120 for operating the on/off of the power supply, the replay and stop of the sound wave signal, the increase and decrease of the sound volume, or the like; an infrared receiving unit 130 for receiving the operation light from an infrared remote controller; a control unit 140 for controlling the replay and stop of the sound wave signal, the increase and decrease of the sound volume, or the like; a data storage unit 160 for reading and storing data (a sound wave signal file) from an external storage device 150 such as an SD card; a replay unit 170 for replaying and amplifying the sound wave signal from the data stored in the data storage unit 160; and a sound output unit 180 for outputting the sound wave replayed by the replay unit 170 from a speaker at a specified sound volume.

The ID transmitter 10-n may further keep an LED of an indication unit 190 lighted if the sound wave signal file to be replayed is two-channel and while the ID transmitter 10-n is detecting the state in which a sound wave of a specified single frequency is recorded on one channel being replayed. This allows the replay status of inaudible sound to be indicated much more in line with the actual conditions.

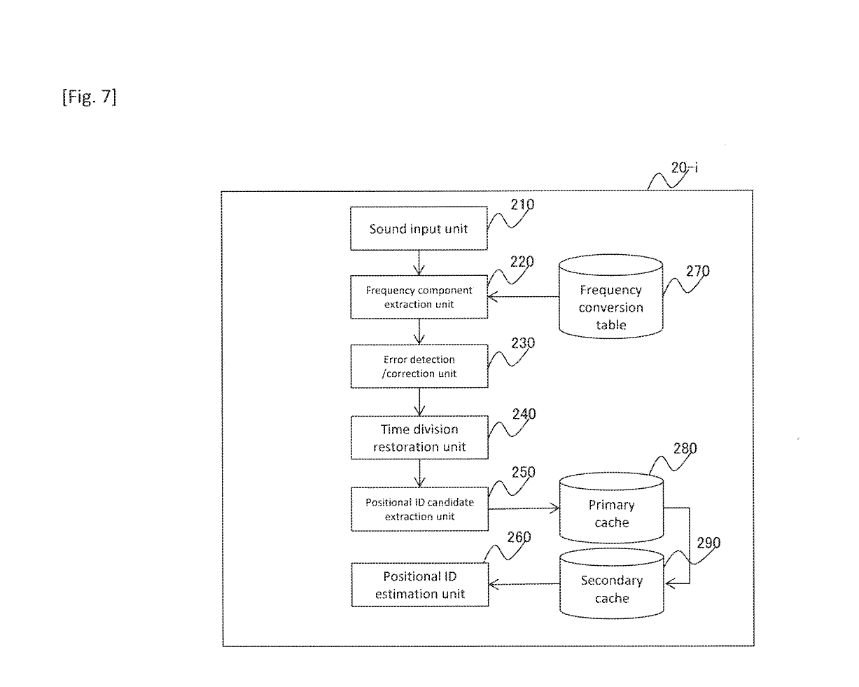

FIG. 7 shows one example of the functional configuration, in the internal configuration of the portable terminal 20-i, about the acquisition of a positional ID. When a smartphone is used as the portable terminal, for example, the portable terminal can be allowed to be configured to use the present system by causing the smartphone to download an application program incorporated with a function to process a sound wave signal to acquire a positional ID and with a function to receive information corresponding to the positional ID from a server or the like.

The portable terminal 20-i comprises a sound input unit 210, a frequency component extraction unit 220, an error detection/correction unit 230, a time division restoration unit 240, a positional ID candidate extraction unit 250, and a positional ID estimation unit 260.

The sound input unit 210 performs a process to code a sound wave inputted through a microphone by digital sampling using, for example, a sampling frequency of 44.1 kHz.

The frequency component extraction unit 220 computes the fast Fourier transform of a sound wave signal to extract the frequency component, and converts the extracted frequency component into a bit string based on a frequency conversion table 270 (FIG. 4) (the value of bits corresponding to existent frequency components are 1, and the value of bits corresponding to nonexistent frequency components are 0). This allows a bit string (15 bits) at one point in time to be acquired.

The error detection/correction unit 230 checks a Hamming code (error correction/detection code) obtained from the lower five bits of the bit string acquired by the frequency component extraction unit 220 against a Hamming code calculated from the upper ten bits, and detects error in the bits. For example, up to two-bit errors are detected and one-bit errors are corrected.

The time division restoration unit 240 fixes the bit string if the error detection/correction unit 230 has detected no error or has been able to correct an error. The time division restoration unit 240 then determines a bit string of the first and second upper bits (two bits) of the fixed bit string as a time slot order (TS number), and passes a bit string of the third through tenth upper bits (eight bits) to the positional ID candidate extraction unit 250 as octet information. At that time, the binary bit strings are converted to hexadecimal form. In this way, which part of the positional ID is formed of the octet information contained in the bit string acquired at this time is specified by the TS number included in the same acquired bit string.

The positional ID candidate extraction unit 250 holds (registers) the bit string passed from the time division restoration unit 240 in a primary cache 280. Octet information and a TS number for one time slot are passed from the time division restoration unit 240 each time a bit string has been able to be fixed, but the middle or last time slot of the first to fourth time slots may be passed first, or an intermediate time slot may be skipped and the next may be passed due to a complete failure to receive the sound wave signal or due to failure to correct errors.

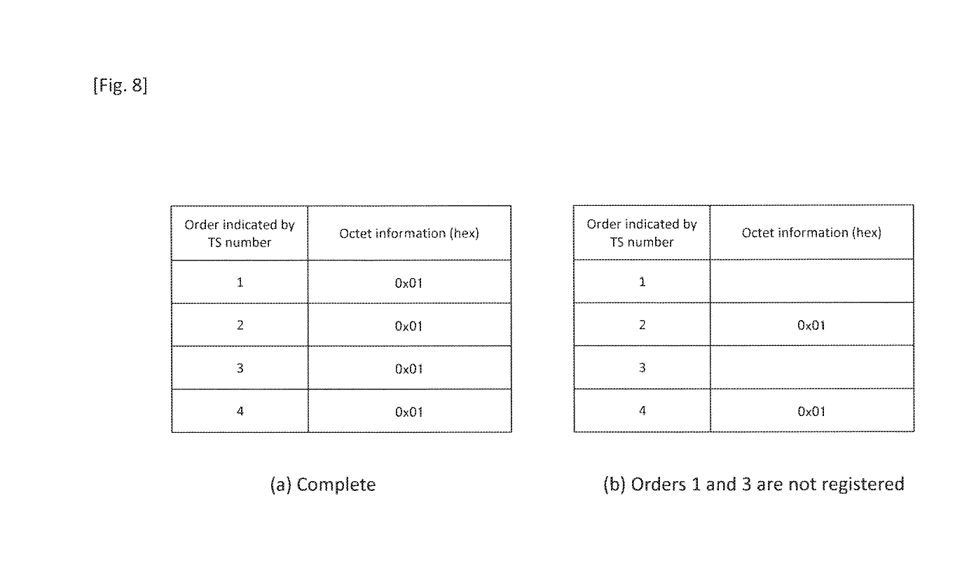

For this reason, the positional ID candidate extraction unit 250 is made to register four items of octet information for one frame in the primary cache 280 not in the order they were past but in the order of the time slots, as shown in FIG. 8. For example, if the fourth time slot is passed first, the fourth item of octet information is registered in the fourth area in the primary cache 280; and if the second time slot is passed then, the second item of octet information is registered in the second area in the primary cache 280 (FIG. 8 (b)).

Since the ID transmitter is repeatedly transmitting the sound wave signals of the first through fourth time slots, the bit string of the third time slot can eventually and normally be received and the third item of octet information is registered in the third area in the primary cache 280 if the portable terminal stays in the same place, and in the same way the bit string of the first time slot can eventually and normally be received and the first item of octet information is registered in the first area in the primary cache 280. Which area in the primary cache 280 the item of octet information passed from the time division restoration unit 240 should be registered in is specified by the TS number simultaneously passed from the time division restoration unit 240.

When octet information is held in all the four time slots (Orders (1) through (4) indicated by TS numbers) in the primary cache 280 (in the example where the positional ID is “01-01-01-01,” the items of octet information are all 0x01 as shown in FIG. 8 (a)), these are converted into character strings, are connected together with “-” separations in order, and are registered in a secondary cache 290 as a positional ID candidate. At the same time, the contents of the primary cache 280 are deleted so that four new time slots of octet information can be registered based on octet information passed from the time division restoration unit 240 next time for the acquisition of the next positional ID candidate.

If a number of time slots of octet information are not yet registered (FIG. 8 (b)), the portable terminal waits until all the relevant items of information is registered. However, if the portable terminal moves from a place within reach of one ID transmitter to a place within reach of another ID transmitter in the mean time, the second and fourth items of octet information belong to one positional ID and the first and third items of octet information belong to another positional ID, and therefore a restored positional ID candidate may become a wrong positional ID.

The secondary cache 290 is provided for such occasions, and a positional ID is determined to be a right positional ID only when the same positional ID candidate has been obtained a plurality of times in a row. In other words, what is used here is that when a wrong positional ID candidate is restored due to the movement of the portable terminal and the resulting mixture of items of octet information before and after the movement, the subsequent positional ID candidate consisting of the items of octet information after the movement is different in value from the previous positional ID candidate.

A large number being set as the number of times that an identical positional ID candidate should be obtained in a row for determination of a positional ID would increase the probability of the determined positional ID being correct. However, too large number would increase the likelihood that a human being with the portable terminal moves to a place to which another positional ID is allocated before the positional ID can be determined.

While in the present example one time slot is 50 ms, one frame is 200 ms, and one positional ID candidate needs at least 200 ms to be obtained, human beings take approximately 750 ms to walk 1 m. Accordingly, if a positional ID is to be fixed when the same positional ID candidate is obtained three times in a row (it takes at least 600 ms to acquire a positional ID), a positional ID can be acquired in a total of four times of acquisition (800 ms) even if items of octet information before and after the move are mixed and a wrong positional ID candidate is obtained at most one time, and therefore a right positional ID can be acquired during the movement of approximately 1 m.

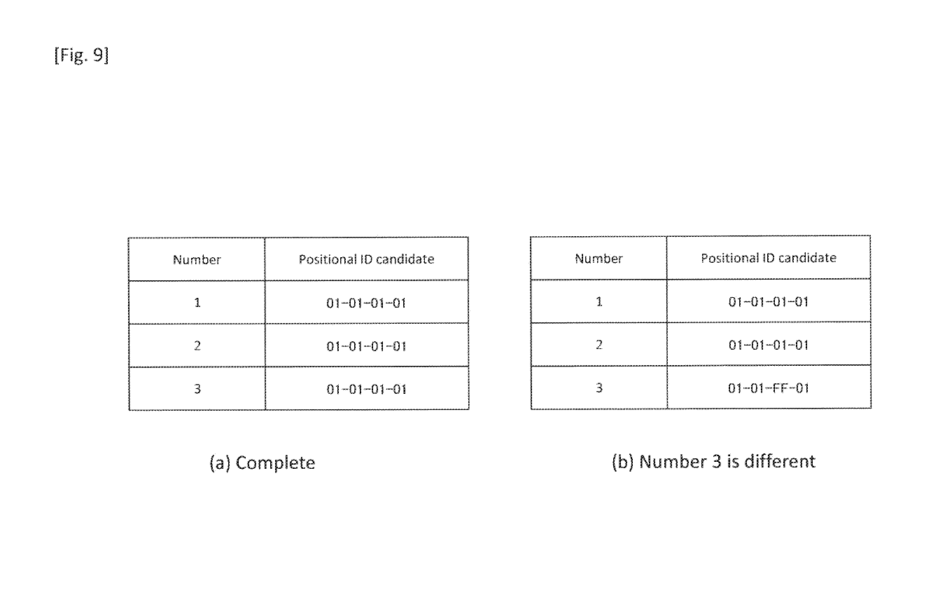

If the condition in which an identical positional ID candidate is obtained three times (or two times) in a row is to be required as described above, three (or two) areas are set up in the secondary cache 290 to hold positional ID candidates as shown in FIG. 9.

When the plurality of areas set up in the secondary cache 290 are filled up and if an identical positional ID candidate exists in all the areas (FIG. 9 (a)), the positional ID estimation unit 260 determines the positional ID to be correct. If there are different positional ID candidates in the secondary cache 290 (as for FIG. 9 (b), the positional ID candidate in the area (3) is different from the positional ID candidate in the other areas (1) and (2)), the area held the earliest is freed on a FIFO (first in, first out) basis so that a positional ID candidate that will be passed from the primary cache 280 next can be held on the tail. This is repeated until all the areas in the secondary cache 290 are filled with an identical positional ID candidate.

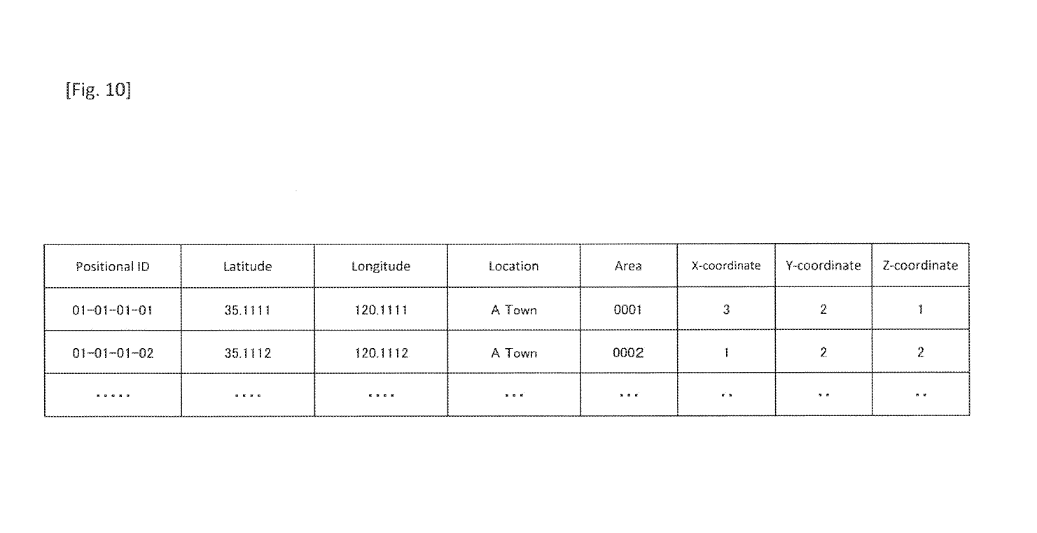

Based on a determined positional ID, the portable terminal can query the position server 400 over the Internet 300 to acquire positional information associated with the positional ID (latitude, longitude, height, location, area, X-coordinate in the area, Y-coordinate in the area, Z-coordinate in the area, etc.). A database deployed on the position server 400 for this purpose contains, for example, items shown in FIG. 10.

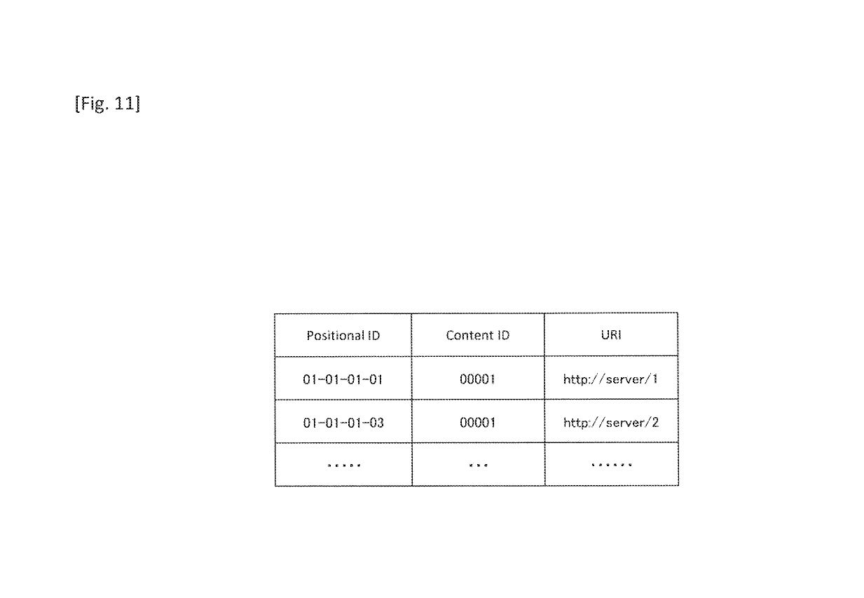

The portable terminal can also query the content server 500 over the Internet 300 to cause it to acquire contents (image, moving image, sound, text, URI, etc.) associated with the positional ID. A database deployed on the content server 500 for this purpose contains, for example, items shown in FIG. 11.

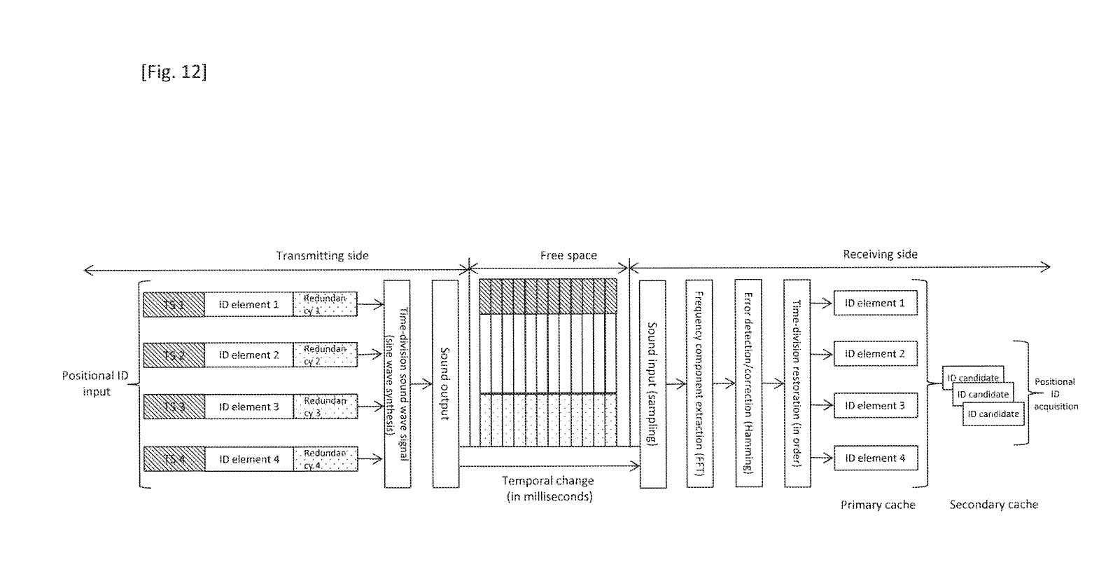

The overall flow related to the transmission and reception of the positional ID using the sound wave is shown in FIG. 12.

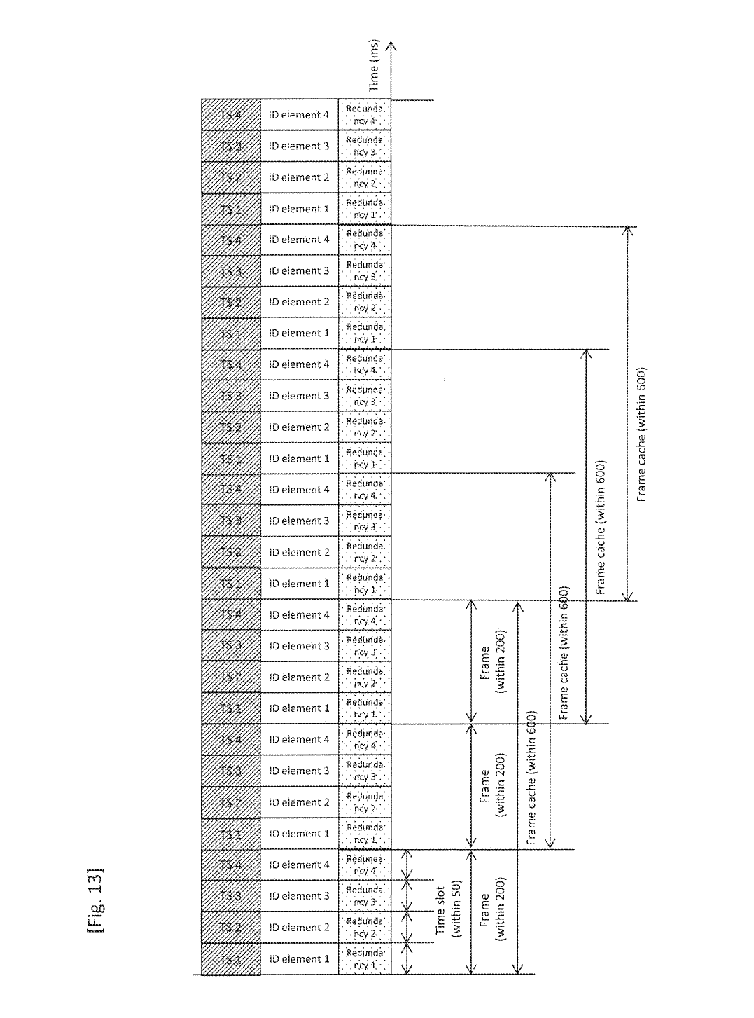

FIG. 13 shows how sound wave signals transmitted from an ID transmitter and a frame cache provided on the receiving side progress as time passes. Since the ID transmitter continues to transmit an identical positional ID, every sound wave signal transmitted in their respective frame is identical. This one positional ID is divided and transmitted in a plurality of time slots (four in the example in FIG. 13). In other words, the ID transmitter temporally divides the positional ID, includes them in sound wave signals, and transmits them.

For this reason, the sound wave signals in the first through fourth time slots may be different from one another, but the sound wave signal in the first time slot in the first frame is the same as the sound wave signal in the first time slot in the following frames, the sound wave signal in the second time slot in the first frame is the same as the sound wave signal in the second time slot in the following frames, the sound wave signal in the third time slot in the first frame is the same as the sound wave signal in the third time slot in the following frames, and the sound wave signal in the fourth time slot in the first frame is the same as the sound wave signal in the fourth time slot in the following frames.

Time-division transmission schemes in the telecommunications field are generally based on two-way communications, and allow information to be acquired in the order of time (the order of time slots) with the transmitting side and the receiving side being temporally synchronized. The present embodiment in which a portable terminal inputs through free space a sound wave outputted from an ID transmitter, on the other hand, does not allow for temporal synchronization and retransmission requests since it is based on one-way communication. Particularly, parallel communication in which a plurality of bits are transmitted simultaneously as in the present scheme conventionally involves timing data transfer by performing a handshake between the transmitting side and the receiving side, but such control cannot be done in one-way communication.

So, even if sound wave signals like in FIG. 13 are being transmitted, it is possible that, for example, the portable terminal on the receiving side is inputted with the sound wave signals in the fourth time slot in the first frame, in the second, third, and fourth time slots in the second frame, and in the first time slot in the third frame, but not with the sound wave signal in the time slot transmitted in the meantime (or that the inputted signal proves to be erroneous).

In this regard, since the sound wave signal in each time slot contains a TS number in part of its own bit string as shown in FIG. 13, the portable terminal on the receiving side can recognize that it received the sound wave signals in the time slots in the order from the fourth through the second, the third (the fourth in the following is already received once, so it is disregarded or substituted for the previous one), to the first, and can rearrange the items of octet information not in the order of reception but in the order of time slots.

Since in the embodiment the portable terminal moves about ID transmitters, the positional ID transmitted by such sound wave signal as shown in FIG. 13 sometimes changes in itself. Besides, the portable terminal on the receiving side cannot distinguish between the state in which the positional ID to be acquired has changed due to the movement from place to place and the state in which the sound wave signal being received has changed due to the deterioration in the sound wave signal propagating in free space having increased with some factors.

So, as shown in FIG. 13, the portable terminal on the receiving side is provided with a frame cache for determining whether a correct positional ID has been acquired or not. Three frames' worth of cache would be provided in the above-described case where a positional ID is determined to be correct when the same positional ID is obtained three times in a row.

Though in FIG. 13 each frame cache is started from the first time slot, they may be started from another time slot depending on the time when the portable terminal started the reception. There may also be a case in which it takes more than 12 time slots' worth time for the three frames' worth cache to be filled up when the portable terminal has not been able to receive some time slots. When the portable terminal has not been able to receive many time slots and a predetermined time period or more has passed before sound wave signals of four time slots have been completely received, information of previously received time slots may be discarded and the start point in time of the frame cache may be renewed on the supposition that the information of the time slots has probably been invalid due to movement or the like.

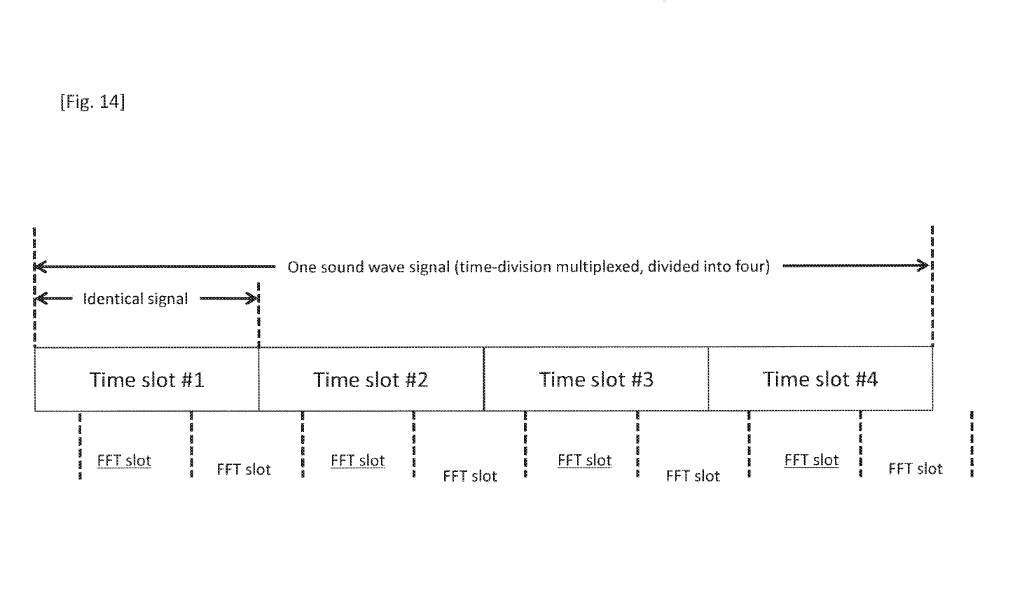

FIG. 14 shows one example of a temporally relationship between time slots for a sound wave signal for transmitting one positional ID on a time-division basis (divided into four in the example in FIG. 14) and FFT slots indicating time intervals at which the FFT process is performed on the receiving side. Time slots #1 through #4 are four temporally divided sound wave signals, which collectively transmit one positional ID. An identical sound wave signal is transmitted during Time slot #1, and is switched to another sound wave signal than the one in Time slot #1 when the time enters Time slot #2. When the signal is divided into four, the sound wave signal in Time slot #4 is followed by the sound wave signal in Time slot #1, so that the sound wave signal for transmitting the positional ID flows repeatedly.

Such sound wave signal is outputted from the ID transmitter on the transmitting side, but since the portable terminal on the receiving side is not temporally synchronized to the ID transmitter, the portable terminal cannot recognize the boundary between time slots when it receives the sound wave signal. For this reason, an FFT slot on the receiving side may span both of Time slots #1 and #2 as shown in FIG. 14. Such an FFT slot would cause frequency components in both of Time slots #1 and #2 to be detected, and therefore a correct bit string could not be restored.

Time equal to or less than half the duration of Time slot #1 on the transmitting side is therefore set as the duration of an FFT slot in the portable terminal on the receiving side. The duration of an FFT slot can be set by, for example, specifying the number of sampling points to be used by the frequency component extraction unit 220 when an application program is installed on the portable terminal to cause it to comprise the functional configuration shown in FIG. 7. This allows an identical sound wave signal to be received in at least one of two FFT slots (time periods indicated with the text “FFT slot” being emphasized in FIG. 4) to restore a correct bit string.

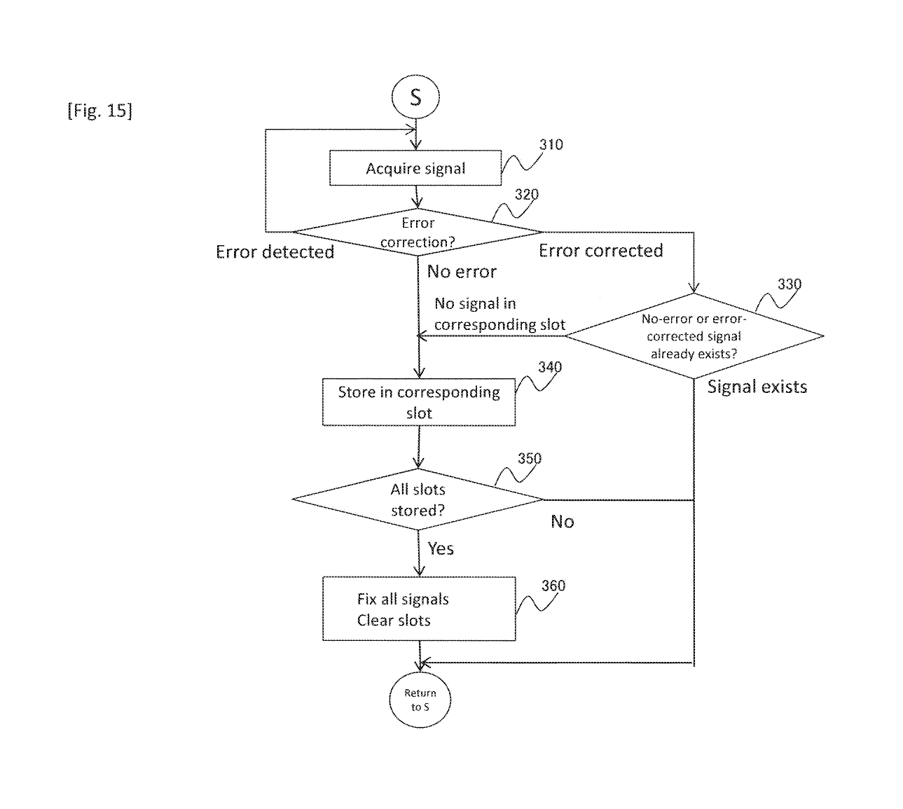

The flow of a concrete process to restore a temporally divided positional ID performed by such portable terminal will be described with FIG. 15. First, the portable terminal inputs a sound wave signal through a microphone and, when it has received one FFT slot's worth of sound wave signal, analyzes the received frequencies using FFT to restore a bit string (S310). The portable terminal then calculates an error correction code for this bit string (S320) and, if an error is detected and cannot be corrected, waits for the next sound wave signal to be received.

If no error is detected, the portable terminal stores, in the primary cache area corresponding to the TS number included in the bit string, the value of octet information included in the relevant bit string (S340). If an error is detected but can be corrected and if nothing is stored in the primary cache area corresponding to the TS number included in the bit string (S330 No), the portable terminal stores there the value of octet information included in the relevant bit string. If the value of octet information is stored in the corresponding primary cache area (S330 Yes), a bit string has already been received for the TS number without error, and therefore the portable terminal does not store the error-corrected bit string and waits for the next sound wave signal to be received.

If the value of octet information is stored in this manner for all time slots (e.g. four slots when the signal is divided into four) (S350), the sound wave signal containing one positional ID is determined to be received, and information of the positional ID (items of octet information connected together) is registered in the secondary cache and is informed of to the application (the positional ID estimation unit 260 etc.) as a positional ID candidate. The values of all the time slots stored in the primary cache are cleared (S360), and the portable terminal waits for the next sound wave signal to be received.

As described in detail above, the present scheme in which a temporally divided sound wave signal is outputted in repeated time slots, in contrast to a scheme in which an identical sound wave signal is outputted continuously, allows the number of bits of a positional ID to be included in the sound wave signal to be increased in proportion to the number of time slots, and allows the number of available positional IDs to be increased.

There is more. A sound wave being emitted from another system than the present system or from nature might be inputted and a wrong positional ID might be acquired if an identical sound wave signal were outputted continuously. In contrast to this, if a sound wave signal having a periodic change is used as in the present scheme, similar sound waves that are not controlled are not likely to exist, and therefore the erroneous recognition of a positional ID decreases and the accuracy is improved, which is also advantageous.

The advantage of the scheme in which an identical sound wave signal is outputted continuously is that a positional ID can be acquired as-is no matter when the portable terminal on the receiving side receives the signal. In contrast to that, however, the present scheme in which a temporally divided sound wave signal is repeated needs some measures so that a correct positional ID is acquired no matter when the portable terminal on the receiving side receives the signal.

The first measure is to include, in an identical sound wave signal to be outputted in each time slot, a bit string of octet information that is part of a positional ID and additionally a bit string of information that indicates which part of the positional ID the octet information forms (TS number of one of the repeated time slots in the above-described example).

The second measure is for the portable terminal to repeat a process in which it receives a temporally divided sound wave signal and restores a positional ID and, in order to improve the reliability of the positional ID, determine that a correct positional ID is acquired only when the same positional ID is obtained a plurality of times in a row.

The third measure relates to the setting of the duration of a time slot. In the present example, the duration of a time slot is set to 40-50 ms.

An upper limit of time that can be set as a time slot is determined, for example, to satisfy T×Y×Z≦750, where: T is the duration of a time slot expressed in milliseconds; Y is the number of time slots required based on the number of bits of a positional ID; and Z is the number of times an identical ID should be obtained in a row on the receiving side in order to determine a positional ID to be correct, since a correct positional ID has to be acquired within approximately 750 ms in order to trap the movement of a human being moving at a walking speed.

A lower limit of time that can be set as a time slot is determined, for example, in consideration of the response speed of speakers of ID transmitters and the accuracy of input and sampling on the receiving side. The duration of a time slot in the configuration shown in FIG. 14 is determined to be equal to or more than twice the duration of an FFT slot. The duration of an FFT slot is determined, for example, based on the number of FFT sampling points required for detecting the spacing between each of the frequencies chosen to express bit strings in sound wave signals, provided that the FFT sampling frequency is fixed (to an appropriate frequency to analyze the uppermost audio frequency range).

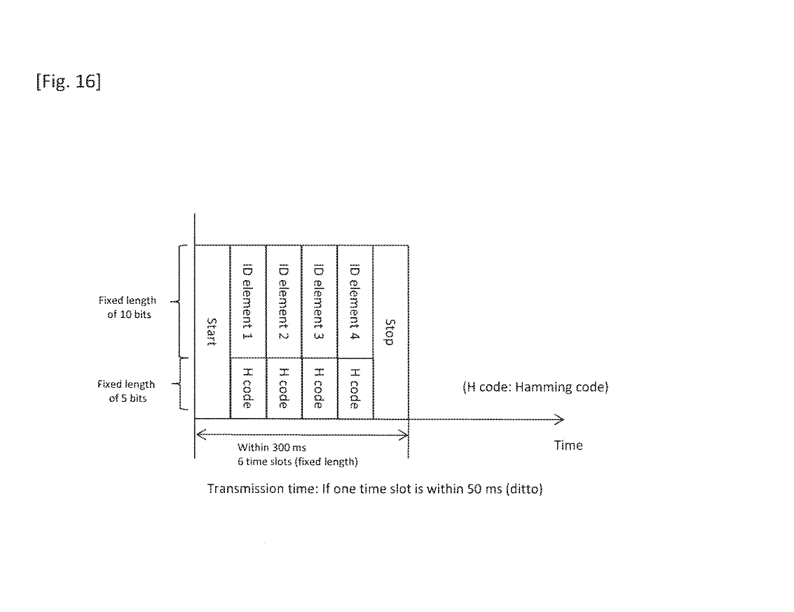

With regard to the first measure described above, if it is only necessary to indicate whether a time slot belongs to an identical frame or not instead of indicating the order of the time slot, the embodiment can be configured with another scheme. The scheme is shown in FIG. 16.

The scheme in FIG. 16 involves: sending out a sound wave signal corresponding to a “start” bit indicating the start; sending out four time slots sequentially with one time slot being a sound wave signal including 15 bits which are ten bits of data resulted from a 40-bit positional ID being divided into four added with a Hamming code (five bits) for error detection/correction of the data; and finally transmitting a sound wave signal corresponding to a “stop” bit indicating the end. Though in this scheme the time length of a frame increases as the time slots for the start and stop are added, the number of bits of a positional ID can also be increased.

The duration of one frame in the scheme in FIG. 16 is within 300 ms provided that one time slot is within 50 ms, since six time slots are necessary for transmitting a whole positional ID. If a positional ID is determined to be correct when the same positional ID is recognized in two frames, the duration of a frame cache is within 600 ms as in the example described before, and the distance a human being walks before a positional ID is acquired (minimum error) is approximately 0.78 m. Consequently, a positional ID can be acquired within 1 m.

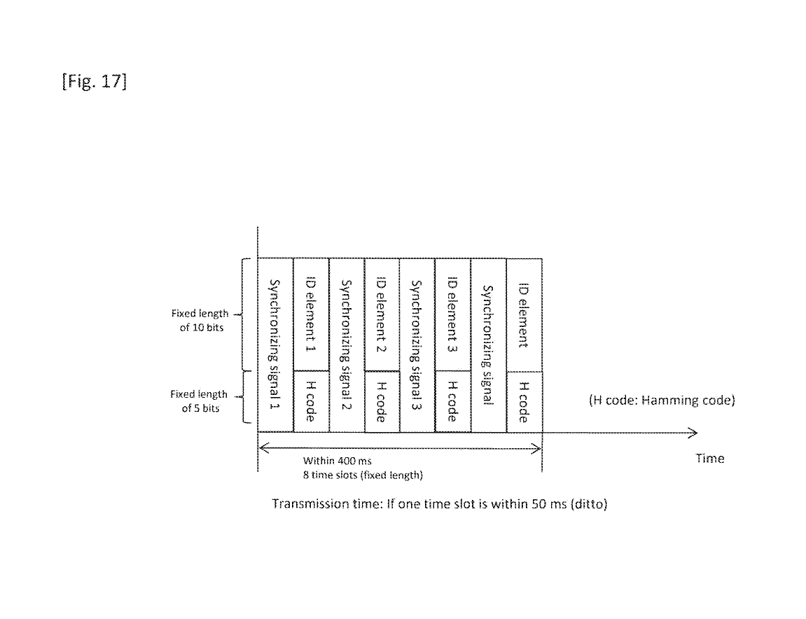

With regard to the first measure described above, if a slight decrease in the ability to follow a human being moving at a walking speed is allowable, the embodiment can be configured with still another scheme, which is shown in FIG. 17.

The scheme in FIG. 17 involves: sending out a sound wave signal corresponding to “Synchronizing signal 1” indicating the start; sending out a time slot being a sound wave signal including 15 bits which are eight bits of data resulted from a 40-bit positional ID being divided into four (a first bit string) added with a Hamming code (five bits) for error detection/correction of the data; sending out a sound wave signal corresponding to “Synchronizing signal 2” in the next time slot; and sending out a sound wave signal of 15 bits including a second bit string in the time slot after. This is repeated, and “Synchronizing signal 4” followed by 15 bits including a fourth bit string are sent out.

The duration of one frame in the scheme in FIG. 17 is within 400 ms provided that one time slot is within 50 ms, since eight time slots are necessary for transmitting a whole positional ID. If a positional ID is determined to be correct when the same positional ID is recognized in two frames, the duration of a frame cache is within 800 ms, and the distance a human being walks before a positional ID is acquired (minimum error) is approximately 1.06 m. Consequently, a positional ID can be acquired in about 1 m.

While embodiments of the invention have been described, the invention is not limited by the description herein and it is a matter of course that various changes and applications may be made thereto within the scope of the invention by those skilled in the art.

1. A sound wave signal output device comprising
means for outputting a sound wave signal comprising one or more sine waves of different frequencies in such a way that a predetermined number of frequencies, which are included in a frequency range that uses an uppermost audio frequency range, correspond to a predetermined number of bits with the value of each bit being expressed by the presence or absence of the output of the sine wave of the corresponding frequency, wherein
information to be transmitted by using the sound wave signal is capable of being associated with a place where the sound wave signal output device is installed, and is divided into a plurality of items of partial information with each item of partial information being expressed by at least part of the predetermined number of bits of the sound wave signal, and
the sound wave signal output device comprises
means for switching at predetermined time intervals the sound wave signal to be outputted, and cyclically outputs sound wave signals expressing the items of partial information in the order the information is formed.

2. The sound wave signal output device according to claim 1, wherein
part of the predetermined number of bits of the sound wave signal express one of the items of partial information, and a remaining part express information that indicates which part of the information said one of the items of partial information forms.

3. The sound wave signal output device according to claim 1, wherein
at least part of the predetermined number of bits of the sound wave signal to be outputted at a certain point in time express information that indicates the start of the information,
at least part of the predetermined number of bits of each of the sound wave signals to be subsequently switched on and outputted in turn express one of the items of partial information, and
at least part of the predetermined number of bits of the sound wave signal to be thereafter switched on and outputted express information that indicates the end of the information.

4. The sound wave signal output device according to claim 1, wherein
at least part of the predetermined number of bits of the sound wave signal to be outputted at a certain point in time express information that indicates which part of the information one of the items of partial information expressed by the sound wave signal to be subsequently outputted forms, and
at least part of the predetermined number of bits of the sound wave signal to be subsequently switched on and outputted express said one of the items of partial information.

5. The sound wave signal output device according to claim 1, wherein
a remaining part of the predetermined number of bits of the sound wave signal form a code for detecting an error in the predetermined number of bits.

6. A sound wave signal control device for controlling a sound wave signal to be outputted by each of a plurality of sound wave signal output devices, the sound wave signal control device comprising:
means for allocating, to each of the sound wave signal output devices, information capable of being associated with a place where said each of the sound wave signal output devices is installed, as information to be transmitted by using the sound wave signal;
means for generating data of a sound wave signal in such a way that the sound wave signal is outputted continuously for a predetermined period of time, the sound wave signal comprising one or more sine waves of different frequencies in such a way that a predetermined number of frequencies, which are included in a frequency range that uses an uppermost audio frequency range, correspond to a predetermined number of bits with the value of each bit being expressed by the presence or absence of the output of the sine wave of the corresponding frequency;
means for generating data of the sound wave signals in such a way that the information is divided into a plurality of items of partial information with each item of partial information being expressed by at least part of the predetermined number of bits, and connecting the data of the sound wave signals for respective items of partial information in the order the information is formed; and
means for passing the connected data of the sound wave signals to the sound wave signal output device allocated with the information.

7. The sound wave signal control device according to claim 6, causing the sound wave signal output device to repeatedly replay the connected data of the sound wave signals, whereby
the sound wave signal to be outputted is switched at predetermined time intervals, and that sound wave signals expressing the items of partial information are cyclically outputted in the order the information is formed.

8. A portable terminal device comprising
means for inputting a sound wave signal comprising one or more sine waves of different frequencies in such a way that a predetermined number of frequencies, which are included in a frequency range that uses an uppermost audio frequency range, correspond to a predetermined number of bits with the value of each bit being expressed by the presence or absence of the output of the sine wave of the corresponding frequency, wherein
information transmitted by using the sound wave signal is capable of being associated with a place where a device for outputting the sound wave signal is installed, and is divided into a plurality of items of partial information with each item of partial information being expressed by at least part of the predetermined number of bits of the sound wave signal, and
the portable terminal device comprises:
means for determining respective values of the predetermined number of bits by detecting frequencies of one or more sine waves that form the inputted sound wave signal at predetermined time intervals; and
means for restoring the information by storing items of partial information obtained based on the respective values of the predetermined number of bits and by assembling the stored plurality of items of partial information in order.

9. The portable terminal device according to claim 8, wherein
the information is restored by obtaining one of the items of partial information from respective values of part of the predetermined number of bits and obtaining information that indicates which part of the information said one of the items of partial information forms from respective values of a remaining part of the predetermined number of bits.

10. The portable terminal device according to claim 8, wherein
the means for restoring the information repeats a process to, after restoring the information, newly store items of partial information obtained based on respective values of the predetermined number of bits and restore the information from the newly stored plurality of items of partial information,
the portable terminal device further comprising
means for determining that the information is acquired without error if identical information is obtained for a predetermined number of times in a row.

11. The portable terminal device according to claim 8, further comprising
means for using respective values of part of the predetermined number of bits as a code for error detection to detect and, if correctable, correct an error in respective values of said predetermined number of bits.

12. The portable terminal device according to claim 8, wherein
sound wave signals from the device for outputting the sound wave signal are switched at predetermined time intervals to be outputted, and
the time interval at which the portable terminal device detects the frequencies is set equal to or less than half the time interval at which the device for outputting the sound wave signal switches the sound wave signal.

13. The portable terminal device according to claim 12, wherein
the means for storing items of partial information obtained based on respective values of the predetermined number of bits stores one of the items in such a way that which part of the information said one of the items of partial information forms is distinguished, and
if an item of partial information obtained based on respective values of the predetermined number of bits and an item of partial information already stored form an identical part, one of the two items is chosen to be used for restoring the information.

14. A sound wave communication system for transmitting information to a portable terminal by using a plurality of sound wave signal output devices that comprise means for outputting a sound wave signal and are installed apart from one another so that areas where each sound wave signal reaches are different from one another, wherein
the sound wave signal comprises one or more sine waves of different frequencies in such a way that a predetermined number of frequencies, which are included in a frequency range that uses an uppermost audio frequency range, correspond to a predetermined number of bits with the value of each bit being expressed by the presence or absence of the output of the sine wave of the corresponding frequency,
information to be transmitted to the portable terminal is capable of being associated with a place where each sound wave signal output device is installed, and is divided into a plurality of items of partial information with each item of partial information being expressed by at least part of the predetermined number of bits of the sound wave signal,
the sound wave signal output devices comprise means for switching at first predetermined time intervals the sound wave signal to be outputted, and cyclically output sound wave signals expressing the items of partial information in the order the information is formed, and
the portable terminal performs a process to determine respective values of the predetermined number of bits by detecting frequencies of one or more sine waves that form the inputted sound wave signal at second predetermined time intervals and, when a plurality of items of partial information obtained based on the respective values of the predetermined number of bits are stored, restore the information by assembling the items in order.

15. The sound wave communication system according to claim 14, wherein
the first predetermined time interval is determined so that the time required for the portable terminal performing the process to input the sound wave signal to obtain an item of partial information as many times as the number of items of partial information that form the information is less than the time required for the portable terminal moving a desired minimum distance.

16. The sound wave communication system according to claim 14, wherein
the portable terminal repeats a process to, after restoring the information, restore the information from items of partial information newly obtained based on respective values of the predetermined number of bits, and determines that the information is acquired without error if identical information is obtained for a predetermined number of times in a row, and
wherein the first predetermined time interval is determined so that the time required for the portable terminal repeating the predetermined number of times performing the process to input the sound wave signal to obtain an item of partial information as many times as the number of items of partial information that form the information is less than the time required for the portable terminal moving a desired minimum distance.

17. The sound wave communication system according to claim 14, wherein
the first and second predetermined time intervals are determined so that the first predetermined time interval is more than twice as long as the second predetermined time interval.

18. The sound wave communication system according to claim 14, wherein
the second predetermined time interval is determined so that any of the predetermined number of frequencies included in a frequency range that uses an uppermost audio frequency range can be detected with a desired accuracy.

19. The sound wave communication system according to claim 14, further comprising
a server device that provides service information unique to the place associated with the information in response to an inquiry based on the information from the portable terminal.

20. A computer program to be installed on a computer to cause the computer to operate as a sound wave signal control device for controlling a sound wave signal to be outputted by each of a plurality of sound wave signal output devices, the computer program comprising:
a program code for executing a process for allocating, to each of the sound wave signal output devices, information capable of being associated with a place where said each of the sound wave signal output devices is installed, as information to be transmitted by using the sound wave signal;
a program code for executing a process for generating data of a sound wave signal in such a way that the sound wave signal is outputted continuously for a predetermined period of time, the sound wave signal comprising one or more sine waves of different frequencies in such a way that a predetermined number of frequencies, which are included in a frequency range that uses an uppermost audio frequency range, correspond to a predetermined number of bits with the value of each bit being expressed by the presence or absence of the output of the sine wave of the corresponding frequency;
a program code for executing a process for generating data of the sound wave signals in such a way that the information is divided into a plurality of items of partial information with each item of partial information being expressed by at least part of the predetermined number of bits, and connecting the data of the sound wave signals for respective items of partial information in the order the information is formed; and
a program code for executing a process for passing the connected data of the sound wave signals to the sound wave signal output device allocated with the information.

21. A portable terminal device program to be installed on a portable terminal device comprising means for inputting a sound wave signal, wherein
the sound wave signal comprises one or more sine waves of different frequencies in such a way that a predetermined number of frequencies, which are included in a frequency range that uses an uppermost audio frequency range, correspond to a predetermined number of bits with the value of each bit being expressed by the presence or absence of the output of the sine wave of the corresponding frequency,
information transmitted by using the sound wave signal is capable of being associated with a place where a device for outputting the sound wave signal is installed, and is divided into a plurality of items of partial information with each item of partial information being expressed by at least part of the predetermined number of bits of the sound wave signal, and
the portable terminal device program comprises:
a program code for executing a process for determining respective values of the predetermined number of bits by detecting frequencies of one or more sine waves that form the inputted sound wave signal at predetermined time intervals; and
a program code for executing a process for restoring the information by storing the items of partial information obtained based on the respective values of the predetermined number of bits and by assembling the stored plurality of items of partial information in order.
